(19) United States
(12) Patent Application Publication
(10) Pub. No.: US 2004/0175456 A1
(43) Pub. Date: Sep. 9, 2004

(54) Tablets for feeding fish and methods of making tablets for feeding fish

(76) Inventors: Lauren Keilbach, New York, NY (US); Robert Falcone, Little Falls, NJ (US); Michael Tyler, Piscataway, NJ (US)

Correspondence Address: GOTTLIEB RACKMAN & REISMAN PC, 270 MADISON AVENUE, 8TH FLOOR, NEW YORK, NY, 100160601

(21) Appl. No.: 10/383,102

(22) Filed: Mar. 6, 2003

(51) Int. Cl. A01K 1/00

(52) U.S. Cl. 426/2

(57) ABSTRACT

One embodiment of the present invention relates to a tablet for feeding fish, comprising: fish food; and binding means which binds the fish food into a substantially solid, homogeneous structure; wherein the binding means includes a gas producing mechanism; wherein the gas production begins essentially contemporaneously with placement of the tablet into water; and wherein the gas releases and disperses the fish food from the tablet. Another embodiment of the present invention relates to a tablet for feeding fish, comprising: fish food; and binding means which binds the fish food into a substantially solid, homogeneous structure; wherein the binding means includes a gas producing mechanism comprising citric acid and sodium bicarbonate; wherein the gas is CO₂; wherein the gas production begins essentially contemporaneously with placement of the tablet into water; wherein the gas releases and disperses the fish food from the tablet; and wherein substantially all of the fish food is dispersed from the tablet within about 45 seconds of placement of the tablet into water. Methods of making tablets for feeding fish are also disclosed.

### FIELD OF THE INVENTION

One embodiment of the present invention relates to a tablet for feeding fish, comprising: fish food; and binding means which binds the fish food into a substantially solid, homogeneous structure; wherein the binding means includes a gas producing mechanism; wherein the gas production begins essentially contemporaneously with placement of the tablet into water; and wherein the gas releases and disperses the fish food from the tablet.

Another embodiment of the present invention relates to a tablet for feeding fish, comprising: fish food; and binding means which binds the fish food into a substantially solid, homogeneous structure; wherein the binding means includes a gas producing mechanism comprising citric acid and sodium bicarbonate; wherein the gas is CO₂; wherein the gas production begins essentially contemporaneously with placement of the tablet into water; wherein the gas releases and disperses the fish food from the tablet; and wherein substantially all of the fish food is dispersed from the tablet within about 45 seconds of placement of the tablet into water.

For the purposes of the present application the term “homogeneous structure” is intended to refer to a structure having a composition which is essentially constant throughout the structure.

Further, for the purposes of the present application the term “solid structure” is intended to refer to a structure lacking in cavities or hollows.

### BACKGROUND OF THE INVENTION

The proper feeding of fish can be an issue for some owners (particularly owners of home aquariums). In this regard, when simple conventional pelleted food or flakes are fed manually the owner may underfeed the fish (which may, of course, be unhealthy for the fish) or overfeed the fish (which may, of course, be unhealthy for the fish and/or cause the aquarium water to get unnecessarily dirty).

Thus, certain feeding systems have been developed to aid in feeding fish. Examples of such conventional feeding systems include: (a) U.S. Pat. No. 5,128,153 to Axelrod (fish food pellet and method of feeding fish); (b) U.S. Pat. No. 5,773,051 to Kim (fish feed and process for its manufacture); (c) U.S. Pat. No. 4,150,162 to Goldstien, et al.(fish feeding product and method of making the same); and(d) U.S. Pat. No. 5,209,746 to Balaban, et al. (osmotically driven delivery devices with pulsatile effect).

### BRIEF DESCRIPTION OF THE DRAWINGS

FIG. 1A shows a perspective view of a tablet in a substantially spherical form according to an embodiment of the present invention;

FIG. 1B shows a perspective view of a tablet in a substantially cylindrical form according to an embodiment of the present invention;

FIG. 1C shows a perspective view of a tablet in a “pill-like” or “cigar-like” form according to an embodiment of the present invention;

FIG. 2A shows a cross-section of the tablet of FIG. 1A along line A-A;

FIG. 2B shows a cross-section of the tablet of FIG. 1B along line A′-A′; and

FIG. 2C shows a cross-section of the tablet of FIG. 1C along line A“-A”.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

In one embodiment a tablet for feeding fish is provided, comprising: fish food; and binding means which binds the fish food into a substantially solid, homogeneous structure; wherein the binding means includes a gas producing mechanism; wherein the gas production begins essentially contemporaneously with placement of the tablet into water; and wherein the gas releases and disperses the fish food from the tablet.

In one example (which example is intended to be illustrative and not restrictive) the gas producing mechanism may comprise an acid and a base.

In another example (which example is intended to be illustrative and not restrictive) the acid may be selected from the group including, but not limited to: (a) citric acid; (b) ascorbic acid; (c) tartaric acid; (d) wine acid; (e) fumaric acid; and (f) maleic acid.

In another example (which example is intended to be illustrative and not restrictive) the base may be selected from the group including, but not limited to: (a) sodium bicarbonate; (b) sodium carbonate; (c) sodium hydrogen carbonate; (d) potassium bicarbonate; (e) potassium carbonate; (f) potassium hydrogen carbonate; and (g) calcium bicarbonate; (h) calcium carbonate; (i) calcium hydrogen carbonate; and k) mono sodium citrate.

In another example (which example is intended to be illustrative and not restrictive) the acid may be citric acid and the base may be sodium bicarbonate.

In another example (which example is intended to be illustrative and not restrictive) the gas may be CO₂.

In another example (which example is intended to be illustrative and not restrictive) substantially all of the fish food may be dispersed from the tablet within about 45 seconds of placement of the tablet into water.

In another example (which example is intended to be illustrative and not restrictive) the fish food may be in the form selected from the group including, but not limited to: (a) extruded food; (b) pelleted food; (c) flaked food; (d) whole freeze-dried food; (e) pulverized pieces of freeze-dried food; (f) broken pieces of freeze-dried food; (g) whole sun-dried food; (h) pulverized pieces of sun- dried food; (i) broken pieces of sun-dried food; and (j) semi-moist food.

In another example (which example is intended to be illustrative and not restrictive) the fish food may be selected from the group including, but not limited to: (a) fish meal; (b) soybean meal; (c) wheat meal; (d) starch; (e) wheat bran; (f) corn powder; (g) seed-gathering gourd; (h) meal powder; (i) wheat embryo bud; (j) dried oil grease; (k) corn gluten; (l) spirulina powder; (m) algae meal; (n) vegetable powder; (o) animal oil; and (p) vegetable oil.

In another example (which example is intended to be illustrative and not restrictive) the tablet may further comprise at least one of: (a) a nutrient; (b) a water treatment; and (c) a medicine.

In another embodiment a tablet for feeding fish is provided, comprising: fish food; and binding means which binds the fish food into a substantially solid, homogeneous structure; wherein the binding means includes a gas producing mechanism comprising citric acid and sodium bicarbonate; wherein the gas is CO₂; wherein the gas production begins essentially contemporaneously with placement of the tablet into water; wherein the gas releases and disperses the fish food from the tablet; and wherein substantially all of the fish food is dispersed from the tablet within about 45 seconds of placement of the tablet into water.

In one example (which example is intended to be illustrative and not restrictive) the fish food may be in the form selected from the group including, but not limited to: (a) extruded food; (b) pelleted food; (c) flaked food; (d) whole freeze-dried food; (e) pulverized pieces of freeze-dried food; (f) broken pieces of freeze-dried food; (g) whole sun-dried food; (h) pulverized pieces of sun- dried. food; (i) broken pieces of sun-dried food; and (j) semi-moist food.

In another example (which example is intended to be illustrative and not restrictive) the fish food may be selected from the group including, but not limited to: (a) fish meal; (b) soybean meal; (c) wheat meal; (d) starch; (e) wheat bran; (f) corn powder; (g) seed-gathering gourd; (h) meal powder; (i) wheat embryo bud; (j) dried oil grease; (k) corn gluten; (l) spirulina powder; (m) algae meal; (n) vegetable powder; (o) animal oil; and (p) vegetable oil.

In another example (which example is intended to be illustrative and not restrictive) the tablet may further comprise at least one of: (a) a nutrient; (b) a water treatment; and (c) a medicine.

In another embodiment a method of making a tablet for feeding fish is provided, comprising: utilizing binding means to bind fish food into a substantially solid, homogeneous structure; wherein the binding means includes a gas producing mechanism; wherein the gas production begins essentially contemporaneously with placement of the tablet into water; and wherein the gas releases and disperses the fish food from the tablet.

In another example (which example is intended to be illustrative and not restrictive) the gas producing mechanism may comprise an acid and a base.

In another example (which example is intended to be illustrative and not restrictive) the acid may be selected from the group including, but not limited to: (a) citric acid; (b) ascorbic acid; (c) tartaric acid; (d) wine acid; (e) fumaric acid; and (f) maleic acid.

In another example (which example is intended to be illustrative and not restrictive) the base may be selected from the group including, but not limited to: (a) sodium bicarbonate; (b) sodium carbonate; (c) sodium hydrogen carbonate; (d) potassium bicarbonate; (e) potassium carbonate; (f) potassium hydrogen carbonate; and (g) calcium bicarbonate; (h) calcium carbonate; (i) calcium hydrogen carbonate; and (j) mono sodium citrate.

In another example (which example is intended to be illustrative and not restrictive) the acid may be citric acid and the base may be sodium bicarbonate.

In another example (which example is intended to be illustrative and not restrictive) the gas may be CO₂.

In another example (which example is intended to be illustrative and not restrictive) substantially all of the fish food may be dispersed from the tablet within about 45 seconds of placement of the tablet into water.

In another example (which example is intended to be illustrative and not restrictive) the fish food may be in the form selected from the group including, but not limited to: (a) extruded food; (b) pelleted food; (c) flaked food; (d) whole freeze-dried food; (e) pulverized pieces of freeze-dried food; (f) broken pieces of freeze-dried food; (g) whole sun-dried food; (h) pulverized pieces of sun- dried food; (i) broken pieces of sun-dried food; and (j) semi-moist food.

In another example (which example is intended to be illustrative and not restrictive) the fish food may be selected from the group including, but not limited to: (a) fish meal; (b) soybean meal; (c) wheat meal; (d) starch; (e) wheat bran; (f) corn powder; (g) seed-gathering gourd; (h) meal powder; (i) wheat embryo bud; (j) dried oil grease; (k) corn gluten; (l) spirulina powder; (m) algae meal; (n) vegetable powder; (o) animal oil; and (p) vegetable oil.

In another example (which example is intended to be illustrative and not restrictive) the tablet may further comprise at least one of: (a) a nutrient; (b) a water treatment; and (c) a medicine.

In another example (which example is intended to be illustrative and not restrictive) the tablet may be color coded.

In another example (which example is intended to be illustrative and not restrictive) the tablet may be color coded using means selected from the group including, but not limited to: (a) a dye; and (b) a pigment.

In another example (which example is intended to be illustrative and not restrictive) the tablet may be color coded to match (i.e., indicate) a characteristic selected from the group including, but not limited to: (a) a pH level; and (b) a species of fish.

In summary, one embodiment of the present invention provides a mixture of powders that would tightly bind into a tablet and rapidly disintegrate when in contact with water releasing food particles into a fish tank.

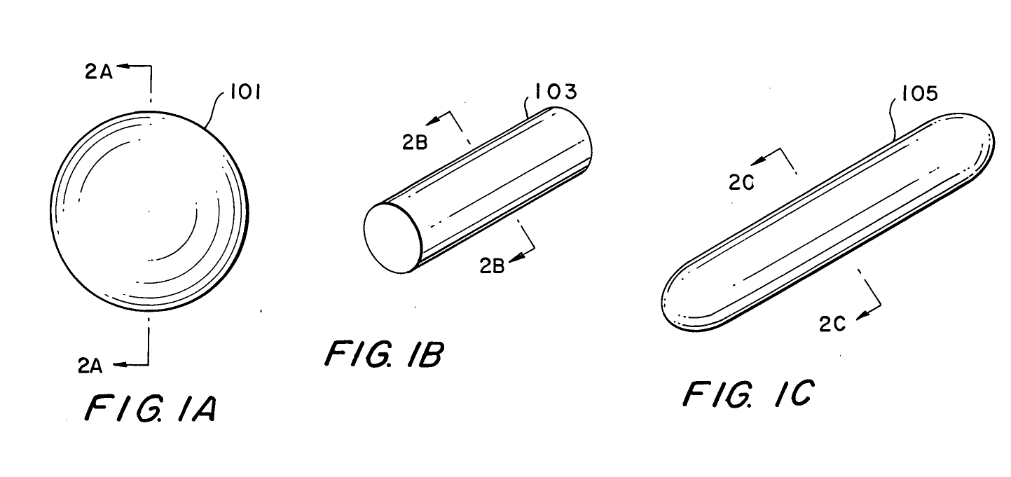

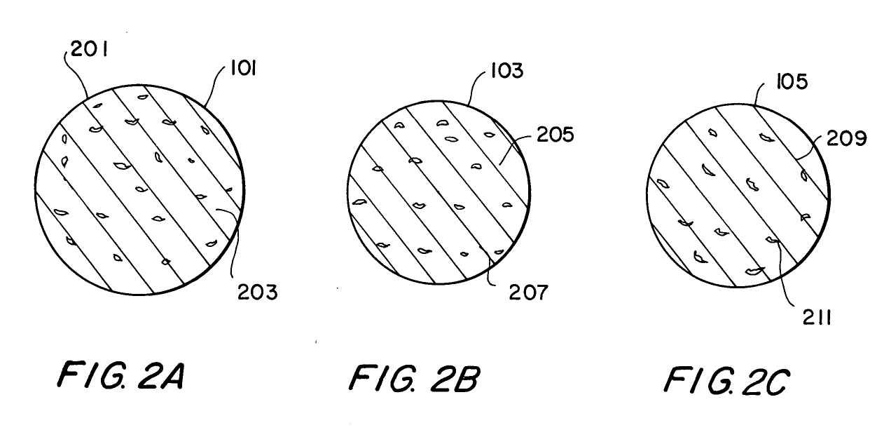

Referring now to FIG. 1A, a perspective view of Tablet 101 in a substantially spherical form is shown. Further, referring now to FIG. 2A, a cross-section of Tablet 101 of FIG. 1A along line A-A is shown. As seen in this FIG. 2A, Fish Food Particles 201 are held together by Binding Material 203 to form Tablet 101. Of note, the proportion of Fish Food Particles 201 to Binding Material 203 may be any desired proportion (e.g., by weight or by volume). Thus, the amount of Fish Food Particles 201 to the amount of Binding Material 203 shown in this FIG. 2A is intended for illustrative purposes only, and is not intended to be restrictive.

Referring now to FIG. 1B, a perspective view of Tablet 103 in a substantially cylindrical form is shown. Further, referring now to FIG. 2B, a cross-section of Tablet 103 of FIG. 1B along line A′-A′ is shown. As seen in this FIG. 2B, Fish Food Particles 205 are held together by Binding Material 207 to form Tablet 103. Of note, the proportion of Fish Food Particles 205 to Binding Material 207 may be any desired proportion (e.g., by weight or by volume). Thus, the amount of Fish Food Particles 205 to the amount of Binding Material 207 shown in this FIG. 2B is intended for illustrative purposes only, and is not intended to be restrictive.

Referring now to FIG. 1C, a perspective view of Tablet 105 in a “pill-like” or “cigar-like” form is shown. Further, referring now to FIG. 2C, a cross-section of Tablet 105 of FIG. 1C along line A″-A″ is shown. As seen in this FIG. 2C, Fish Food Particles 209 are held together by Binding Material 211 to form Tablet 105. Of note, the proportion of Fish Food Particles 209 to Binding Material 211 may be any desired proportion (e.g., by weight or by volume). Thus, the amount of Fish Food Particles 209 to the amount of Binding Material 211 shown in this FIG. 2C is intended for illustrative purposes only, and is not intended to be restrictive.

In operation, one or more of the inventive tablets (e.g., depending upon the number of fish and/or the species of fish and/or the size of the aquarium) are simply placed into the aquarium (whereby gas is produced and the fish food is released and disbursed as described herein).

In another embodiment the present invention provides a tablet that is durable yet rapidly breaks apart when in contact with water (whereupon the tablet releases food particles into the aquarium). The food particles may be a complete diet and may provide all the required nutrition to one or more species of fish. In one example (which example is intended to be illustrative and not restrictive) a combination of microcrystalline cellulose and dextrates may allow for the compressibility and durability of the tablet. An acid/base reaction, plus (PVP) may allow for the rapid disintegration and short dissolution time of the tablet when the tablet comes into contact with water (wherein food will be released into the water). In this regard, it is noted that PVP is the synonym for Poly(VinylPyrrolidone) and that Polyvinylpyrrolidone (PVP) is a macromolecular polymer of N-vinylpyrrolidone. PVP is a holding matrix that enables the quick absorption of water (thus allowing the acid/base react to occur in a more controllable manner).

Depending on the nature of the food, the food may float to the top, float between the top and bottom, and/or sink to the bottom. This method of delivering food may be used to feed any desired species of fish. Of note, the invention may be used to feed fish a variety of different sized extruded and/or pelleted food, as well as, flaked food, whole freeze-dried food, flake fines, ingredients and/or supplements.

In another embodiment the present invention provides a method of releasing food particles into an aquarium from an effervescent tablet.

In another embodiment the present invention provides a unique way of delivering a complete diet to any desired species of fish.

In another embodiment the present invention provides a method comprising mixing a certain percentage of food with a certain percentage of binding material and pressing or forming into a tablet. In one example (which example is intended to be illustrative and not restrictive) the ingredients may be pre-dried and the dry powders may be mixed until evenly distributed.

In another embodiment the present invention provides for the use of Lutavit C (i.e., L-Ascorbyl-Monophosphate, a monophosphate form of ascorbic acid). Of course, other forms of ascorbic acid may be used, for example polyphosphate.

In another embodiment the present invention provides for the acid and base (e.g., citric acid and sodium bicarbonate) to be added in a specific ratio to achieve a desired dissolution time. In one example (which example is intended to be illustrative and not restrictive), the ratio of citric acid to sodium bicarbonate may be about 2.42:72.78, with a dissolution time of about 15 seconds. In other examples (which examples are intended to be illustrative and not restrictive), the ratios may be about 2.26:67.94 and 2.5:65. In another example (which example is intended to be illustrative and not restrictive), the range of citric acid may vary from 2-3%; the range of sodium bicarbonate may vary from 60-80%; and the dissolution times may range from 10-40 seconds.

In another example (which example is intended to be illustrative and not restrictive), a tablet having the formula shown below in Table 1 may be provided.

TABLE 1

| 1906/26/Y | % | 750 g | complete |
|---|---|---|---|
| tri-sodium citrate | 2.3 | 17.25 | |
| lutavit C | 0.5 | 3.75 | |
| disintex | 10 | 75 | |
| dextrates | 9 | 67.5 | |
| MCC | 3 | 22.5 | |
| citric acid | 2.42 | 18.15 | |
| soduim bicarbonate | 72.78 | 545.85 | |
| Betta Food | | 250 g | |

Regarding the use of disintex, it is noted that disintex 75 is a 2-Pyrrolidinone,1 ethenyl-, Homopolymer made by the International Specialty Products Technologies Corporation (CAS # 9003-39-8). Use of disintex may enable fast water absorption (thus enabling a faster dissolution rate). It is believed that this product is presently being used for detergents for faster dissolution.

Regarding the use of dextrates, it is noted that a dextrate is a spray crystallized dextrose containing small amounts of starch oligosaccharides. It is believed to be a highly refined product composed of white, free-flowing, spray-crystallized macroporous spheres with a median particle size of 190-220 mm. Dextrates may also be known as solid binders as well as pharmaceutical excipients. A chemical description may be as follows: 93% Dextrose Monohydrate & 7% maltodextrin (CAS # 68131-37-3).

In another embodiment the present invention provides: (a) a relatively short dissolution time (e.g., less than about 45 seconds); (b) very little or no residue; (c) no liquid ingredients; and (d) a complete diet.

In another embodiment the present invention provides a tablet for use with aquarium fish (e.g., as a pet food).

In another embodiment the present invention provides a matrix that can be used for food as well as nutrient(s), water treatment(s), supplement(s), chemical(s), etc.

In another embodiment the present invention provides for use of hygroscopic powder(s). Of note, in one embodiment such hygroscopic powder(s) should remain relatively dry until use of the tablet.

In another embodiment the present invention provides a food delivery system that takes the form of a durable tablet which may disintegrate in about 45 seconds or less and which may deliver a complete diet to one or more desired species of fish.

In another embodiment of the present invention the ascorbic acid may comprise vitamin C.

In another embodiment the present invention provides a tablet containing a portion that is an acid and a portion that is a base, whereby the acid and base allow for effervescence (production of CO₂).

While a number of embodiments of the present invention have been described, it is understood that these embodiments are illustrative only, and not restrictive, and that many modifications may become apparent to those of ordinary skill in the art. For example, each tablet may be directed to one or more specific species of fish (e.g., in terms of tablet size, tablet nutritional value, additive(s), supplement(s), medicine(s), etc) and/or different amounts of fish and/or different sizes of aquariums and/or different types of aquariums and/or different types of water. Further, each tablet may be substantially spherical, substantially cylindrical, substantially cylindrical with substantially hemispherical ends (e.g., “pill-like” or “cigar-like”), or any other desired shape. Further still, the vegetable powder may comprise any desired vegetables, such as spinach, carrot, peas and/or zucchini, for example. Further still, the acid may be any desired low to medium molecular weight carboxylic acid and/or the acid may be an anhydride (such as fumaric anhydride and maleic anhydride, for example).

What is claimed is:

1. A tablet for feeding fish, comprising:
fish food; and
binding means which binds the fish food into a substantially solid, homogeneous structure;
wherein the binding means includes a gas producing mechanism;
wherein the gas production begins essentially contemporaneously with placement of the tablet into water; and
wherein the gas releases and disperses the fish food from the tablet.

2. The tablet of claim 1, wherein the gas producing mechanism comprises an acid and a base.

3. The tablet of claim 2, wherein the acid is selected from the group including: (a) citric acid; (b) ascorbic acid; (c) tartaric acid; (d) wine acid; (e) fumaric acid; and (f) maleic acid.

4. The tablet of claim 2, wherein the base is selected from the group including: (a) sodium bicarbonate; (b) sodium carbonate; (c) sodium hydrogen carbonate; (d) potassium bicarbonate; (e) potassium carbonate; (f) potassium hydrogen carbonate; and (g) calcium bicarbonate; (h) calcium carbonate; (i) calcium hydrogen carbonate; and (j) mono sodium citrate.

5. The tablet of claim 2, wherein the acid is citric acid and the base is sodium bicarbonate.

6. The tablet of claim 5, wherein the gas is CO₂.

7. The tablet of claim 1, wherein substantially all of the fish food is dispersed from the tablet within about 45 seconds of placement of the tablet into water.

8. The tablet of claim 1, wherein the fish food is in the form selected from the group including: (a) extruded food; (b) pelleted food; (c) flaked food; (d) whole freeze-dried food; (e) pulverized pieces of freeze-dried food; (f) broken pieces of freeze-dried food; (g) whole sun-dried food; (h) pulverized pieces of sun-dried food; (i) broken pieces of sun-dried food; and (j) semi-moist food.

9. The tablet of claim 1, wherein the fish food is selected from the group including: (a) fish meal; (b) soybean meal; (c) wheat meal; (d) starch; (e) wheat bran; (f) corn powder; (g) seed-gathering gourd; (h) meal powder; (i) wheat embryo bud; (j) dried oil grease; (k) corn gluten; (l) spirulina powder; (m) algae meal; (n) vegetable powder; (o) animal oil; and (p) vegetable oil.

10. The tablet of claim 1, further comprising at least one of: (a) a nutrient; (b) a water treatment; and (c) a medicine.

11. A tablet for feeding fish, comprising:
fish food; and
binding means which binds the fish food into a substantially solid, homogeneous structure;
wherein the binding means includes a gas producing mechanism comprising citric acid and sodium bicarbonate;
wherein the gas is CO₂;
wherein the gas production begins essentially contemporaneously with placement of the tablet into water;
wherein the gas releases and disperses the fish food from the tablet; and
wherein substantially all of the fish food is dispersed from the tablet within about 45 seconds of placement of the tablet into water.

12. The tablet of claim 11, wherein the fish food is in the form selected from the group including: (a) extruded food; (b) pelleted food; (c) flaked food; (d) whole freeze-dried food; (e) pulverized pieces of freeze-dried food; (f) broken pieces of freeze-dried food; (g) whole sun-dried food; (h) pulverized pieces of sun-dried food; (i) broken pieces of sun-dried food; and (j) semi-moist food.

13. The tablet of claim 11, wherein the fish food is selected from the group including: (a) fish meal; (b) soybean meal; (c) wheat meal; (d) starch; (e) wheat bran; (f) corn powder; (g) seed-gathering gourd; (h) meal powder; (i) wheat embryo bud; (j) dried oil grease; (k) corn gluten; (l) spirulina powder; (m) algae meal; (n) vegetable powder; (o) animal oil; and (p) vegetable oil.

14. The tablet of claim 11, further comprising at least one of: (a) a nutrient; (b) a water treatment; and (c) a medicine.

15. A method of making a tablet for feeding fish, comprising:
utilizing binding means to bind fish food into a substantially solid, homogeneous structure;
wherein the binding means includes a gas producing mechanism;
wherein the gas production begins essentially contemporaneously with placement of the tablet into water; and
wherein the gas releases and disperses the fish food from the tablet.

16. The method of claim 15, wherein the gas producing mechanism comprises an acid and a base.

17. The method of claim 16, wherein the acid is selected from the group including: (a) citric acid; (b) ascorbic acid; (c) tartaric acid; (d) wine acid; (e) fumaric acid; and (f) maleic acid.

18. The method of claim 16, wherein the base is selected from the group including: (a) sodium bicarbonate; (b) sodium carbonate; (c) sodium hydrogen carbonate; (d) potassium bicarbonate; (e) potassium carbonate; (f) potassium hydrogen carbonate; and (g) calcium bicarbonate; (h) calcium carbonate; (i) calcium hydrogen carbonate; and (j) mono sodium citrate.

19. The method of claim 16, wherein the acid is citric acid and the base is sodium bicarbonate.

20. The method of claim 19, wherein the gas is CO₂.

21. The method of claim 15, wherein substantially all of the fish food is dispersed from the tablet within about 45 seconds of placement of the tablet into water.

22. The method of claim 15, wherein the fish food is in the form selected from the group including: (a) extruded food; (b) pelleted food; (c) flaked food; (d) whole freeze-dried food; (e) pulverized pieces of freeze-dried food; (f) broken pieces of freeze-dried food; (g) whole sun-dried food; (h) pulverized pieces of sun-dried food; (i) broken pieces of sun-dried food; and (j) semi-moist food.

23. The method of claim 15, wherein the fish food is selected from the group including: (a) fish meal; (b) soybean meal; (c) wheat meal; (d) starch; (e) wheat bran; (f) corn powder; (g) seed-gathering gourd; (h) meal powder; (i) wheat embryo bud; (j) dried oil grease; (k) corn gluten; (l) spirulina powder; (m) algae meal; (n) vegetable powder; (o) animal oil; and (p) vegetable oil.

24. The method of claim 15, wherein the tablet further comprises at least one of: (a) a nutrient; (b) a water treatment; and (c) a medicine.

25. The tablet of claim 1, wherein the tablet is color coded.

26. The tablet of claim 25, wherein the tablet is color coded using means selected from the group including: (a) a dye; and (b) a pigment.

27. The tablet of claim 25, wherein the tablet is color coded to match a characteristic selected from the group including: (a) a pH level; and (b) a species of fish.

28. The tablet of claim 11, wherein the tablet is color coded.

29. The tablet of claim 28, wherein the tablet is color coded using means selected from the group including: (a) a dye; and (b) a pigment.

30. The tablet of claim 28, wherein the tablet is color coded to match a characteristic selected from the group including: (a) a pH level; and (b) a species of fish.

31. The method of claim 15, wherein the tablet is color coded.

32. The method of claim 31, wherein the tablet is color coded using means selected from the group including: (a) a dye; and (b) a pigment.

33. The method of claim 31, wherein the tablet is color coded to match a characteristic selected from the group including: (a) a pH level; and (b) a species of fish.
